(19) United States
(12) Patent Application Publication
(10) Pub. No.: US 2007/0073808 A1
(43) Pub. Date: Mar. 29, 2007

(54) MOBILE MESSAGING SYSTEM

(76) Inventors: ALAN BERREY, NOVI, MI (US); AARON HEINER, NORTHVILLE, MI (US)

Correspondence Address: ARTZ & ARTZ, P.C., 28333 TELEGRAPH RD., SUITE 250, SOUTHFIELD, MI, 48034, US

(21) Appl. No.: 11/534,258

(22) Filed: Sep. 22, 2006

Related U.S. Application Data
(60) Provisional application No. 60/720,107, filed on Sep. 23, 2005.

(51) Int. Cl. G06F 15/16

(52) U.S. Cl. 709/204

(57) ABSTRACT

A method for messaging between an enterprise and clients of the enterprise who each have a mobile device operatively connected via a wireless communication link to a telecommunication network, and wherein at least two clients have different wireless service providers. The method includes receiving a plurality of message files from the enterprise, each message file including a client identity and message information; associating a wireless device and a wireless service provider with each client identity; composing a mobile-terminated message to the wireless device of the identified client as a function of the message information; and delivering the message to the client wireless device. The method also provides receiving a mobile-originated message from the client in response to the mobile-terminated message and, thereafter, composing and delivering a second mobile-terminated message to the same wireless device as a function of at least one data field within the mobile-originated message.

### CROSS REFERENCE TO RELATED APPLICATION

The present application claims priority from U.S. Provisional Application Ser. No. 60/720,107 filed on Sep. 23, 2005, and entitled “Mobile Collect System”.

### TECHNICAL FIELD

The present invention relates to an electronic notification system and, more specifically, to a system and method of providing text message notifications to a wireless device user.

### BACKGROUND

Collecting debt is an essential and expensive part of most businesses. Consumer debt is ever increasing and, in the United States, approximately 4% of payments are late each month. Collecting payments has never been more difficult. Yet, traditional mechanisms for communicating with clients or debtors have significant drawbacks. Traditionally, debt notification has occurred by telephone interaction, mail, and more recently by e-mail. Traditional telephone calls provide excellent dialogue capabilities; but telephone calls are expensive, require extensive manpower, and are easily filtered. Printed letters are less expensive than traditional telephone calls, but they are very slow and only reach people through conventional mail processes. Email notification has been an effective mechanism for notifying a debtor of the current status of an account, or when payment is due. Again, though, email notices are easily ignored or filtered. Presently, no system allows for wireless handling of debt messaging, subsequent resolution of the debt notification, or further interactivity of such a notice with its originator.

One medium being explored for reaching out to customers and debtors is mobile messaging. Mobile communication has become the most widely used communications medium in the world. The number of mobile subscribers exceeds the number of fixed telephone lines, and there are more mobile handsets in daily use than personal computers and televisions combined. Over a billion text messages are sent around the world every day. Further, text messaging (SMS) is the most common form of data service currently available on mobile devices. Text messaging is fast, effective and less expensive than traditional forms of communications. Furthermore, many younger customers prefer text messages over other traditional forms of communications.

Mobile device users typically have only one or two communications service providers. However, banks and other creditors may have millions of customers, not all of which can be reached through a single communications service provider. Moreover, text messages result in fees incurred by both the sender and recipient. It would be desirable to utilize text messaging to reach customers at almost any location and at any time, without any fees incurred by the mobile device user.

Accordingly, there exists a need for a centralized mobile notification system that provides text messaging as a communication medium for companies and particularly, creditors, to reach customers or debtors. Furthermore, it would be desirable to provide debt notification messaging, for example, at no cost to mobile device users. The present invention is directed toward such a system.

### SUMMARY OF THE INVENTION

A Mobile Notification System (“MNS”) provides businesses a unique solution for direct message notification to customers with mobile devices, regardless of the user's communications service provider and without cost to the mobile device user. One embodiment provides direct message notification to end users of account status, activity, due notices, balances, and other account reports that are keyed from an enterprise system. The notification to or from the user may be by a wireless communication interface, and the notification may be originated, created and directed by the Mobile Notification System. Notices are provided in text message form and may also entail any text forms of the non-audible variety. The Mobile Notification System provides one-way notification, but also includes two-way messaging capabilities.

In one embodiment, a messaging system for enabling messaging dialogue between an enterprise and a client of the enterprise who has a mobile device operatively connected via a wireless communication link to a telecommunication network, is provided. The system includes a Mobile Dialogue Engine (MDE) connected by a communications network to the enterprise, the MDE includes program instructions stored in memory. The instructions include first instructions for receiving a plurality of message files from the enterprise, wherein each message file includes a client identity and message information. Second instructions are provided for associating a wireless device and a wireless service provider with each client identity, and third instructions are provided for composing a mobile-terminated message to the wireless device of the identified client as a function of the message information. Fourth instructions are provided for delivering the message to the client wireless device. At least two of the clients have different wireless service providers.

In a further aspect, a Mobile Enterprise Gateway (MEG) interface is provided between the MDE and the enterprise. The MEG includes program instructions stored in memory, the program instructions comprising instructions for preprocessing the message files from the enterprise for format validity. A Mobile Message Center (MMC) interface between the MDE and the enterprise is also provided. The MMC includes program instructions stored in memory, the program instructions comprising instructions for composing a free-form mobile-terminated message to the wireless device of the identified client. A Mobile Carrier Gateway (MCG) interfacing the MDE with the telecommunications network is also provided. The MCG includes program instructions stored in memory, the program instructions comprising instructions for transmitting each mobile-terminated message to the wireless device of the identified client by the client's wireless service provider. Also, a Mobile Regulation Integrator (MRI) is provided which is operatively associated with the MDE. The MRI includes program instructions stored in memory, the program instructions comprising instructions for validating a wireless device network number and a wireless service provider for each client identity.

A method for messaging between an enterprise and clients of the enterprise who each have a mobile device operatively connected via a wireless communication link to a telecommunication network is also provided. The method is directed toward enterprises wherein at least two clients have different wireless service providers. The method includes receiving a plurality of message files from the enterprise, each message file including a client identity and message information; associating a wireless device and a wireless service provider with each client identity; composing a mobile-terminated message to the wireless device of the identified client as a function of the message information; and delivering the message to the client wireless device. The method also provides receiving a mobile-originated message from the client in response to the mobile-terminated message and, thereafter, composing and delivering a second mobile-terminated message to the same wireless device as a function of at least one data field within the mobile-originated message. The step of receiving a mobile-originated message can include determining whether the mobile-originated message is at least one of an exact-match, free-form or invalid message format. In another aspect, the method includes storing all message dialogues between an enterprise and its clients.

In another embodiment of a method according to the present invention, a method is provided for messaging between an enterprise and clients of the enterprise who each have a mobile device operatively connected via a wireless communication link to a telecommunication network. The method includes identifying a plurality of client identities in response to a common trigger event, wherein at least two of the clients have different wireless service providers; providing a data point for each of the clients, the data point correlating to a pre-defined message text; and transmitting a message file to a server. The message file includes the data points. The server is operatively connected to a gateway for delivering mobile-terminated messages as a function of the data points to the clients. The method also includes receiving a report indicating messaging activity with each of the clients. Also, in response to transmitting, the method includes receiving a mobile-originated message from at least one of the clients. In response to receiving a mobile-originated message from a client, the method allows the enterprise to compose a free-form message, and transmit the free-form message to the client. The pre-defined message text can be selected from a plurality of pre-defined message texts.

The system is advantageous because it utilizes text messaging to reach customers at almost any location and at any time. Text messaging is used advantageously because mobile devices are monitored throughout the day by their users.

Other objects and advantages will become apparent upon reading the following detailed description. While the system is described below in conjunction with the enterprise system of a typical financial services institution, it is only one example of the businesses in which the present system may be used to advantage. The present system may be used with different enterprise systems including but not limited to, retailers, event promoters, automotive dealerships, marketing companies, and many other businesses who have a need to communicate with customers.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows a schematic view of the Mobile Notification System, including the Mobile Dialogue Engine, implemented in a wireless network according to one embodiment of the present invention.

FIG. 2 shows a logic flow diagram of message processing by the MDE according to an embodiment of the present invention.

FIG. 3 shows a logic flow diagram of an embodiment of the interface of the MDE, MEG and an enterprise client.

FIG. 4 shows a logic flow diagram of an information exchange with the MMC.

FIG. 5 shows a process flow diagram of one example of a Mobile Notification System according to an embodiment of the present invention.

### DESCRIPTION

In the following description, various operating parameters and components are described for one or more constructed embodiments. These specific parameters and components are included as examples and are not meant to be limiting.

While the invention is described with respect to a Mobile Notification System for use as a debt collection and notification system, the system is capable of being adapted for various businesses including retailers, customer service organizations, dry cleaners, automotive dealership service and sales centers, concert event planners, and marketing companies, just to name a few without limitation.

The Mobile Notification System provides a wireless notification to a mobile device user over an extremely effective network. In one example, the system is used to provide notification to a debtor. The system may be used not only for initiating a notification with a debtor, but for also maintaining dialogue with a debtor. The system uses the addition of mobile wireless technology and text messaging to connect directly with target debtors in a more cost effective and timely basis than previously used notification mechanisms. Advantageously, the Mobile Notification System allows banks, as an example, to engage individuals, i.e., debtors or end users, in dialogue at any time and from almost any location.

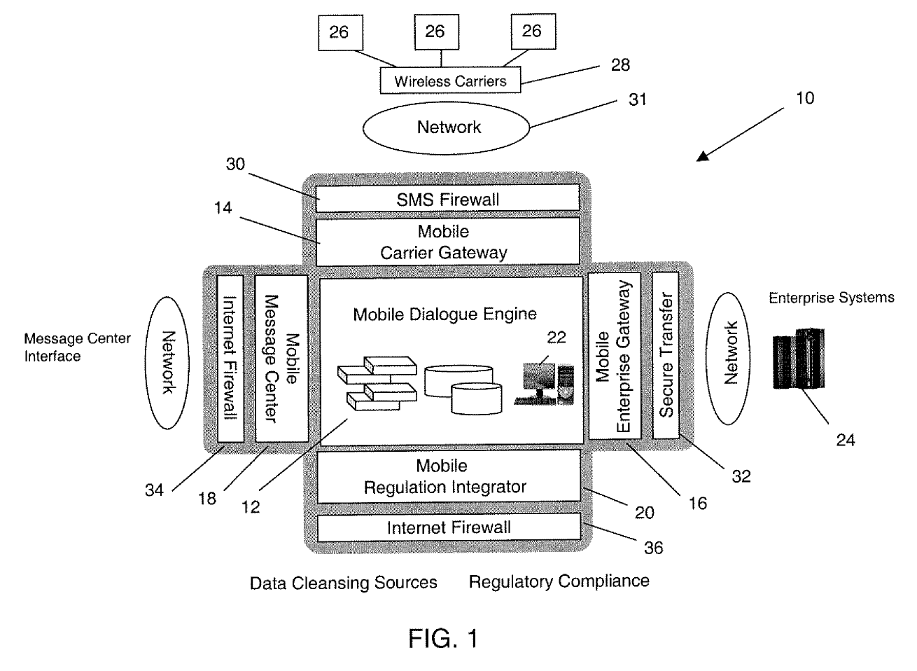

FIG. 1 shows a schematic view of the Mobile Notification System, including the Mobile Dialogue Engine, implemented in a wireless network according to one embodiment of the present invention. There are several components that may be implemented to support the overall Mobile Notification System and solution. Accordingly, the major components of the novel system and the relationships of the components involved in the system will now be described with reference to FIG. 1.

The Mobile Notification System (MNS) 10 has a framework of distinct system and wireless components that enable complete mobile communications solutions. As shown in FIG. 1, there are five primary components in the Mobile Notification's technology solution. The five primary components include: a Mobile Dialogue Engine (MDE) 12; a Mobile Carrier Gateway (MCG) 14; a Mobile Enterprise Gateway (MEG) 16; a Mobile Message Center (MMC) 18; and a Mobile Regulation Integrator (MRI) 20. A layer of security utilities is shown surrounding these components.

The Mobile Dialogue Engine 12 is at the heart of the MNS framework 10. The MDE 12 processes all incoming mobile messages and processes the messages within the context of any previous messages dialogue. The MDE 12 enforces all processing rules and priorities. The MDE 12 includes a Mobile Message Queue (MMQ) 22 to ensure that all messages are processed as quickly as possible and that the overall architecture is easily scaled and supported.

The MDE 12 facilitates text message correspondence between Mobile Notification System's enterprise customers such as a bank 24, and the bank's debtors who are also mobile device subscribers 26. This correspondence takes place as an automated process predefined by configuration screens. It includes support for mobile originated (MO) and mobile terminated (MT) messages. Thus, besides sending outgoing messages to the bank's customers 26, it can process incoming messages within the context of any previous message dialogue. The MDE 12 also ensures that all communication is recorded and tracked.

The MDE 12 is developed as a common component. The MDE 12 can be in the form of a conventional personal computer or computer workstation with sufficient memory and processing capability. The MDE 12 includes program instructions stored in memory either locally or on a network storage device. It also is operatively associated with a plurality in databases containing message histories, client data files and rules, wireless carrier protocols, security authentication rules, etc. In one embodiment, the MDE 12 operates as a web server, both receiving and transmitting data generated by client 24 and device users 26. The MDE 12 is preferably capable of high volume transaction processing in processing communications and database searches. Data storage for such information may include hard disk magnetic or optical storage units, as well as CD-ROM or DVD drives, flash memory, or any known data storage mechanism. Databases used in processing messages in the present invention can include a company database, message database, security database, and billing database, for example. Some of these databases will be described in greater detail below with reference to the interaction between the MDE 12, customers 24 and device users 26.

In addition to running stand-alone, the MDE 12 is also designed to used as a building block for other applications. The MDE is designed with flexibility, modularity, and extensibility in mind. Thus, it can be implemented on a single computer, or a network of computers. The MDE 12 allows almost instant dialogue with most mobile customer at almost any location. Preferably, messages received at the MDE 12 are processed immediately. The MDE 12 is in the center of the Mobile Notification System's functionality. It is the core of all other components. The other four components that reside on top of the MDE 12 include the Mobile Carrier Gateway (MCG) 14, the Mobile Enterprise Gateway (MEG) 16, the Mobile Message Center (MMC) 18 and the Mobile Regulation Integrator (MRI) 20. Each of these components is described briefly below.

Unlike the public Internet which permits access to all websites and email addresses through a single connection, mobile networks are private. Connection in one location does not guarantee access elsewhere. But, the Mobile Carrier Gateway (MCG) 14 enables dialogue with one or many different mobile carriers 28. The MCG can connect directly to the carriers or through a representative company typically referred to as “text message aggregators”. Aggregators run systems for the wireless carriers and are paid by clients such as the MNS and by the carriers to support text messaging on behalf of the carriers. The MNS can establish connection with an aggregator, and hand the messages off to the aggregator to place that message onto the appropriate network, i.e. Cingular, Verizon, Nextel or another. Thus, the MCG 14 manages all connections to the carriers 28 and scales automatically to support varying levels of message volumes. Through operating agreements with as many wireless carriers and aggregators as possible, the MCG 14 can grant an enterprise customer 24 access to each of the carrier networks and, more importantly, their mobile customers 26 who are also customers of the enterprise business 24. Thus, the MCG 14 provides a single access point to carriers 28 and customers 26. The MCG 14 utilizes the robust standard Short Message Peer-to-Peer Protocol (SMPP) which provides flexibility and scalability. Through the MCG 14, the MDE 12 can connect clients 24 to a specific carrier's network or simultaneously connect many carriers and aggregators. The MCG 14 may be part of or separate from the MDE 12. The MEG 16 also includes program instructions stored in memory, either locally or on a network storage device, for carrying out its functions.

A short message service (SMS) firewall 30 resides between the MCG 14 and the wireless carriers 28 to filter incoming messages. The SMS firewall 30 serves as a protection for all messages, incoming and outgoing, by checking each message against an active list of known wireless viruses. The list is actively updated at regular intervals, as is known in the art.

The Mobile Enterprise Gateway (MEG) 16 allows clients to connect existing customer relationship management (CRM), enterprise resource planning (ERP), and other existing systems to the mobile communications channel. The MEG 16 supports basic and sophisticated data formats, including XML, fixed-width or token-separated values. By integrating mobile applications with existing enterprise data sources the system 10 allows customers 24 to create highly valuable and compelling mobile solutions. Communications between the MEG 16 and clients 24 occurs through a secure transfer platform 32. Secure data transmissions can occur in real-time or according to scheduled processing. The Mobile Enterprise Gateway 16 is a mechanism for receiving files from the enterprise customer system and evaluating the files to make sure that they are valid before further processing. The MEG performs high-level evaluation of the file to make sure it is a valid format and structure, and then the file is processed via the Mobil Dialogue Engine 12. The MEG 16 may be part of or separate from the MDE 12. The MEG 16 also includes program instructions stored in memory, either locally or on a network storage device, for carrying out its functions.

In order to validate the file with the MEG, a set of rules are pre-defined for each enterprise customer. For instance, a bank may have a list of customers who are two days late on payments as of a certain date. Upon receiving the file from the bank, a lookup is performed in the MDE for the rules (set by the bank) to apply to messages for customers who are two days late. The file is validated by the MEG against these rules which specify the file parameters. Further, the rules are applied to create the desired messages. In some cases the bank might provide additional information such as the balance due or the date that the payment was originally due. Almost any parameter can be included into the message body itself.

The Mobile Message Center (MMC) 18 provides access to automated dialogue definitions and visibility to all past messages. The MMC 18 facilitates manual intervention in an SMS dialogue. Many common messages (predefined dialogues) are handled through automatic response by the MDE. However, there will be cases when customer interaction will fall outside the predefined dialogue path. In these cases the Mobile Message Center 18 is used to process messages from a queue populated by the MDE. Through the use of MMC representatives, companies 24 can support endless forms of dialogue with their customers 26.

The MMC 18 allows a client 24 to quickly send a text message to one targeted person 26, as well as send bulk messages where lists of recipients are included. In one example, the MMC 18 is used in large call centers where text messages are used to augment telephone, email, and fax communications. The MMC 18 allows clients 24 to view all mobile dialogue through an Internet connection to the MEG 16 and MDE 12. The MMC 18 provides users 24 the ability to create unique message texts for broadcasting to their customers 26. By defining message text, the MMC 18 permits chat-type discussions with mobile users 26 easily. The MMC operates through an Internet interface 34. For example, marketing departments can use the MMC to create and send campaign follow-up messages, alerts, or coupons. In another example, financial institutions can use the MMC to create messages for payment reminders to groups of debtors 26.

The MMC 18 also supports reports to the enterprise customers 24. How many messages were sent today and yesterday, and how many obtained a response, for example. The MMC can provide more than aggregate level reporting. Enterprise customers can data mine the individual activity of an individual debtor through the MMC interface as well. The MMC can be a user friendly interface providing top level activity monitoring, and data mining for a particular wireless device user in order to respond to a dialogue with that user. In contrast, the reports that go to the customers through the MEG can be very detailed, long reports structured primarily for automated analysis by the customer's internal systems. The MMC can be implemented as part of the MDE, or be a separate component. The MMC also includes program instructions stored in memory for performing its functions.

In order to provide a turn-key solution to customers 24, the Mobile Notification System 10 interfaces and obtains data from several third party sources through the Mobile Regulation Integrator (MRI) 20. The MRI can be part of the MDE, or a separate component. The MRI 20 also includes program instructions stored in memory for performing its functions. The MRI, acting through an Internet interface 36, allows the MDE to distinguish cellular telephone numbers from landlines. It also allows the MDE to identify the relevant carrier for each of the wireless numbers.

The following describes each of these components, and their interaction, in more detail.

The interface between the MDE 12 and enterprise customers 24, through the MEG 16 will now be described in greater detail. In this example, every client 24 is provided with one primary administrative user account. The user account is accessed through a MDE Administration Homepage which allows the client to update their profile, create/manage dialogue tree configurations, and manage user accounts. Preferably, only the primary administrative user account will be able to access the MDE Administration Homepage. If the customer 24 has access to a module supporting multiple users, then the system can provide the ability to create/modify multiple accounts. Preferably, there is only one administrative user account per client. For each account, usernames should be unique across the entire system. A user account may comprise: unique system identifier (a.k.a. username); name; password; password hint; user type; permissions; and active flag, for example. The administrative user for each customer 24 can have the ability to reset the password for any user accounts associated with the administrative accountant. The MDE Administration Homepage should dynamically create the screens presented to the customer 24 based the modules configured for the particular user.

As an example, a typical customer profile can comprise: local time zone setting; contact information both for error notification and report distribution; name and address information; account number; billing information; pricing rules; configured modules; FTP location; pre/post pay flag; message credits; active flag; and short/long code configuration. The MDE should support both long and short codes, and the configuration should specify which type of number is being used. All correspondence for the client is sent using the assigned code if one is specified. When dynamic codes are used, a specific code is assigned to the client. In this case, the MDE 12 dynamically assigns a code for correspondence from a pool of available codes. The customer is only be able to modify its contact, name, and address information. All other information in the customer profile is maintained by the Mobile Notification System staff.

Basic text message dialogues are created within the MDE 12 using what is referred to as the Web Dialogue Engine. More detailed dialogues can be created with the MMC 18 disclosed below. The MDE 12 provides a set of administrative screens used to define dialogue trees. A dialogue tree is a hierarchical structure mapping MT messages to MO messages, and MO messages to an MT message. Each MT message can have a set of valid MO responses. MO messages, on the other hand, can only have one corresponding MT to use as a response. Preferably, there is no limitation on the depth or breadth of the dialogue tree.

Validation, chaining and state are maintained according to traversal of the dialogue tree. Thus, if dialogue is initiated via an MT message, the corresponding tree should begin with an MT. Likewise, dialogue initiated by an MO message should begin with an MO message. Both MO and MT messages can support parameterization. These parameters can be predefined or dynamic. Inserting the MO message text as a parameter in an MT message is an example of a predefined parameter. Inserting an account number from a file is an example of a dynamic parameter. The MDE 12 can populate dynamic parameters from a file or from the database.

In general, the MDE 12 will view MO messages as responses to an MT. Two types of MO messages are available, exact-match and free-form. MO text received from a mobile device must “exactly match” the text of an exact-match MO, excluding text case, to be accepted. The set of valid responses defined for an MT can contain any number of exact-match MO messages and, at most, one free-form MO. All MO text received from a mobile device is checked for a match within the list of exact match MO texts. If a match is not found in the list then the text will be accepted as a free-form MO, if one is defined. An exception occurs when the MO text is the beginning of a dialogue tree on a shared short code scenario. In such a case, the MO is defined as an exact-match MO text.

MO and MT messages cannot be longer than 160 characters under current text messaging protocols. Thus, only messages meeting this criterion are saved to a dialogue tree. Maximum allowed parameter lengths can also be used as part of the validation process. Of course, should the messaging protocol change to provide different message formats, including greater than 160 characters, the present invention contemplates using such modified messaging schemes.

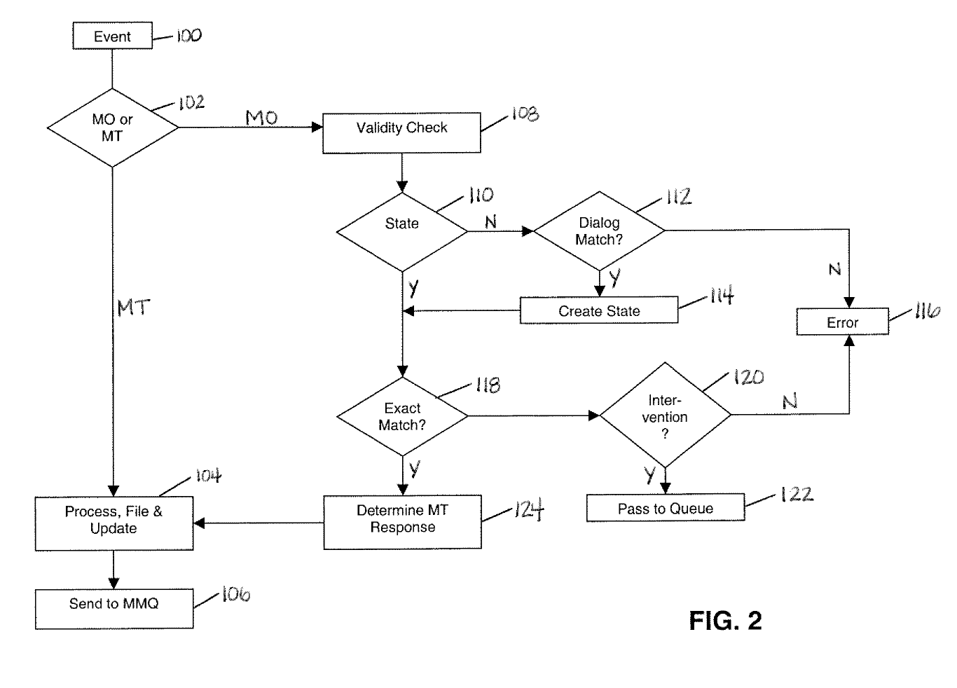

FIG. 2 shows a logic flow diagram of message processing by the MDE according to an embodiment of the present invention. All wireless messages, both sent and received, are managed by the MDE 12. This component depends on a Message Transport Layer for sending messages to and receiving messages from the wireless carriers 28. The MDE 12 controls all message validation, state, chaining, and storage.

Message processing is only allowed after the proper chaining/auditing has occurred. The MDE uses current state and message type (MO or MT) to determine how messages are handled. State is stored by short/long code and mobile number and includes information such as client, dialogue tree, and last message sent/received.

Upon an event 100, the MDE determines the message type 102. MT messages are processed 104 according to client rules. MT messages are then passed to the Mobile Message Queue in step 106 for delivery to the Short Message Service Center (SMSC) for broadcast through the various wireless carrier networks to website device users 26. It is the responsibility of the MDE to assign a short/long code to each MT based on client configuration and state prior to passing it to the Mobile Message Queue 22. The MDE also updates the state 104.

MO messages are checked for validity at 108 by the MDE. Message validity is determined differently depending on whether or not current state exists 110. When no state exists, a message will be considered valid only if the MDE can find a dialogue tree that matches the current MO text 112. When located, the dialogue tree is used to create the initial state 114 for this mobile number. If a match can not be found an error is returned 116 letting the user know the request was not understood. When state does exist, the set of valid responses defined for the previous MT message sent is used to determine validity. If the type of MO texts contained in the set are both exact-match and free-form, the MDE will check all exact-match MO texts first 118 and use the free-form MO as a last resort. If the client setup allows manual intervention 120, the message is placed in a queue 122 to be processed by the corresponding module. At this point it is assumed that all processing control is turned over to the external module. Otherwise, the MDE will lookup the default error response 116 for the client 24.

In either case, if the MO text is valid, the MDE uses the location of the current MO message in the dialogue tree to determine the MT message to use as a response 124. State information is updated to clearly represent the chosen tree traversal path.

A Message Transport Layer (MTL) can be created between the MDE 12 and the SMSC 31, and can reside in the MDE 12 or MCG 14. The MTL allows flexibility in SMSC communication mechanisms. Thus, many implementations can be provided such as HTTP, SMPP, or an SMSC-specific API. The Mobile Notification System 10 can then change SMSC providers or communications mechanisms with little or no impact to the enterprise clients 24. The transport layer provides the ability to physically send and receive SMS messages. The transport layer also logs any errors encountered during message receipt or delivery to the database. If message delivery confirmation is available via the implementation mechanism, then the transport layer is responsible for tracking and updating the message delivery status of all outbound messages.

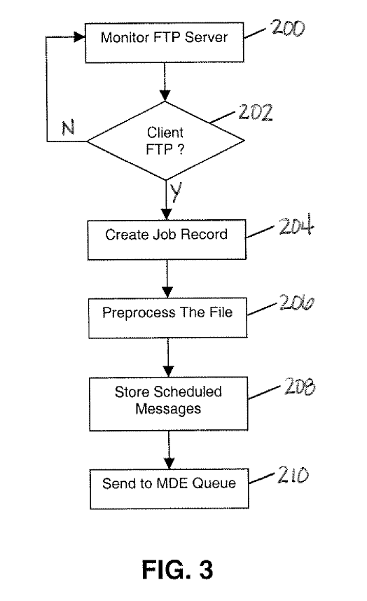

FIG. 3 shows a logic flow diagram of an embodiment of the interface of the MDE, MEG and an enterprise client. The MEG is an extension of the MDE. Each enterprise client has a unique File Transfer Protocol (FTP) account which is used to communicate with the MEG and MDE. The MEG 16 uses the FTP server to access and share files with the external systems associated with the enterprise customers. Configurations defined within the MEG databases specify the expected file types and formats for these client FTP files.

Configuration definitions are used to determine how the MEG processes a file. There is no limit on the number of configurations the enterprise client can have. User interface screens through the Client Administration Homepage allow customers to create/view/modify all configuration definitions. This user interface can be the only mechanism a client has to create/view/modify a configuration definition. Further, the only user account capable of creating a configuration is the administrative user account for the particular customer.

Each configuration may comprise a dialogue tree as defined in the Mobile Dialogue Engine (MDE). In such a case, the configuration will simply store a reference to the dialogue tree. The configuration may also include a name and type of the file providing the data (CSV, fixed-width, XML, etc), information required for scheduling delivery, regulation integrators to be used, and delivery confirmation and result file generation flags. The FTP location and contact information can be determined from each customer profile. Each customer should be able to generate a sample file based on the format defined by each configuration.

No formatting is performed on the parameter values received in an FTP file. It is assumed that all formatting requirements are complied with on the customer side. Each record in the file will have one or more telephone numbers. Telephone numbers may be followed by zero, one, or many parameter values. The name of the file will be used to associate a particular configuration with the data file on the FTP server. The type designated will be used to determine how the file will be processed.

As shown in FIG. 3, the MEG constantly monitors 200 the FTP server for the presence of a valid file to process 202. The MEG configuration settings are used to determine the validity of the files found. A list of valid files for a particular client can be determined by looping over all configurations defined for the client. When a valid file is located 202, it is moved to a temporary directory and preprocessed. A job record can be created 204 that stores any pertinent information about the job. This can include statistics about the job such as the number of records processed, the number of phone numbers checked to determine mobile status, and a count of mobile numbers found. A job status can also be associated with the record.

Pre-processing 206 comprises reading the entire file, using the MRI to determine which numbers are mobile, populating the parameters for the first MT message in the dialogue tree of the configuration, and scheduling the message for delivery. Scheduled messages will be stored in the database 208 with all pertinent information such as mobile number, message text, and scheduled delivery time. When the scheduled delivery time is determined, settings for message delivery spanning and time zone adjustments should be taken into account. Once the file has been preprocessed, it can also be moved into an archive directory for the enterprise customer 24.

The MEG is responsible for processing batch jobs. It can use the job records created as part of the requirement to determine when a job should be processed. Once pre-processed, an MT message is created for each message scheduled for delivery, and is passed to the MDE for processing 210. Ultimately, message delivery confirmation is handled by the Message Transport Layer associated with the MDE.

Thus, as with the MDE, the MEG provides a layer of validation for messages. That is, when an FTP file is received from a customer, the system first ensures that the overall file is formatted correctly. This includes ensuring that general format of the file complies with an appropriate configuration definition for each customer. The MEG also ensures that the FTP file itself is not truncated, or misconfigured in such a way that the file cannot be processed. If the file does not pass this first level of validation, it is rejected completely, and the system makes no attempt at processing any individual records. If the file passes the first level of validation within the MEG, the file moves into the second level of validation which addresses the validity of the individual records within the file. In the second level of file validation, the system ensures that each individual record can be processed correctly. There may be a record in the file that is completely blank, or does not comply with the formatting requirements. In such a case, the MEG can process other records in the file but not one or more individual records.

The MEG uses the MRI to validate mobile telephone numbers. An example of this is a service to lookup if a phone number is a mobile number or a land line. The MEG can use any number of MRI implementations to provide different levels of compliance checks. The regulation integrators to be used are defined as part of the configuration process for each enterprise customer.

Further, each customer can have the ability to cancel a job up until it is flagged as complete in step 208. At a cancellation request, no more messages will be sent out for the corresponding job. Cancellation reports can be made available via a status report on the Client Administration Homepage. Other reports can also be made available through the Client Administration Homepage.

Once a file is processed and in the queue of the MDE, delivery to mobile users can occur in many ways. In one simple example, delivery scheduling can provide start and end time constraints based on time of day. The MDE can also provide the ability to specify a specific date for message delivery. In one embodiment, the MDE instantly distributes all processed messages. In such a case, if a specific date is desired then the file should not be placed on the FTP server for processing until that day. The file will be processed as long as it is on the FTP server prior to the end time specified. If the end time has passed for the day, then the file will be processed the following day. These files can nevertheless be pre-processed by the MEG as soon as they are placed on the server to immediately identify any errors in the file format.

Delivery scheduling can occur in other ways. Delivery scheduling can allow all messages to be sent out at once, or spread out over an even distribution spanning a specified time window, i.e., deliver all messages over the course of four hours. Timed delivery of the messages can occur with respect to the local time at the call center location, or they can be adjusted according to the time zone of the recipient mobile number registration location. A best attempt can then be made to deliver the messages within the specified time window. The time zone of the call center is stored as part of the enterprise customer profile.

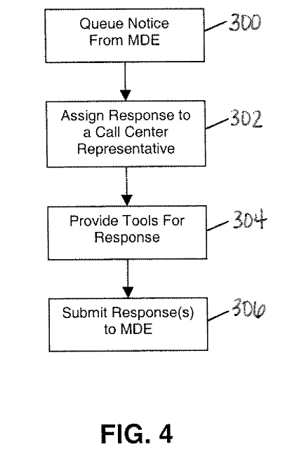

Referring now to FIG. 4, there is shown one embodiment of an information exchange with respect to the Mobile Message Center 18. The MMC 18 can be used to facilitate manual intervention in an SMS dialogue between a customer 24 and its clients who are mobile device users 26. As mentioned above, many common cases can be handled through automatic response by the MDE. However, there will be cases when customer interaction will fall outside the predefined dialogue path. In these cases the Mobile Message Center is used to process messages from a queue populated by the MDE 12. Through the use of MMC representatives, companies 24 can support endless forms of dialogue with their clients 26. The MMC can also aggregate messages directed to an enterprise customer that fall outside the rules defining valid dialogues for that specific customer. In this way, customers 24 can log into the system and manually respond or process any messages directed toward them from their clients.

The MMC can support multiple customers 24. Customer accounts are created and managed via functionality provided by the MDE. In one example, the MMC Homepage available to customers provides: the ability to search for existing dialogue via a mobile number; a queue of messages waiting for a manual response; the tools necessary to create and send a response to messages in the queue; a list of frequently used messages to accelerate the response process; and a list showing the dialogue history for the active message in the queue.

The MMC monitors the MDE queue for messages 300 and assigns them to a specific call center representative 302. Preferably, all correspondence for a dialogue chain should go through the same representative as long as they are available. Rules can be used to determine the call center representative a particular message should be assigned to. Several data points can be considered in assigning messages such as whether the dialogue chain has been previously assigned to a representative; whether the representative still logged on to the system; if not, how long they have been inactive; and how long should a representative be inactive before a dialogue chain should be reassigned.

Once the message is assigned to a call center representative, several tools are available for the representative to use in responding 304. The call center representative can access previous dialogue through a search feature by entering the mobile number of the dialogue desired. The resulting list shows the last message in each dialogue chain with the most recent listed at the top. The call center representative can choose to view or respond to a particular dialogue chain, or they can choose to initiate an entire new thread. They can also search all existing dialogue for the customer 24 or end user 26.

Like a phone-based representative, a call center representative can only respond to one message from the queue at a time. The message currently being processed is considered the active message in the queue. When a message is selected for processing, the dialogue history is loaded along with a message editor to formulate a response. As the representative enters text in the message editor, an indicator update to show how many characters are remaining before the 160 character maximum is reached. Currently, text messaging will only support 160 characters per message. Messages longer than 160 characters must be broken into multiple messages. In one example, the text editor can limit responses to 5 messages of 160 characters per message. Once the message is complete, the representative submits the message back to the MDE for processing in step 306. Once a response has been sent, the mobile number will be removed from the queue.

The queue for each representative can be configured in any number of known ways, similar to telephone representative queues. In this example, all call center representatives will have their own message queue. When a call center representative logs on to the system, the messages in their queue are displayed. The list of un-responded messages automatically refreshes itself on a configurable timeframe (every 60 seconds for example). This refresh should not cause the entire page to reload since the representative may be in the process of generating a response. The queue can display the mobile number, the first 20 characters (or some “preview” length) of the message received, and the time the message was received. The list should be sorted by receipt timestamp with the oldest showing at the top of the list. Depending on the number of messages showing in the queue, the list may be further broken down into manageable pages. The representative should have the ability to select the message they want to respond to. Of course, other queue schemes are contemplated by the present invention, as well.

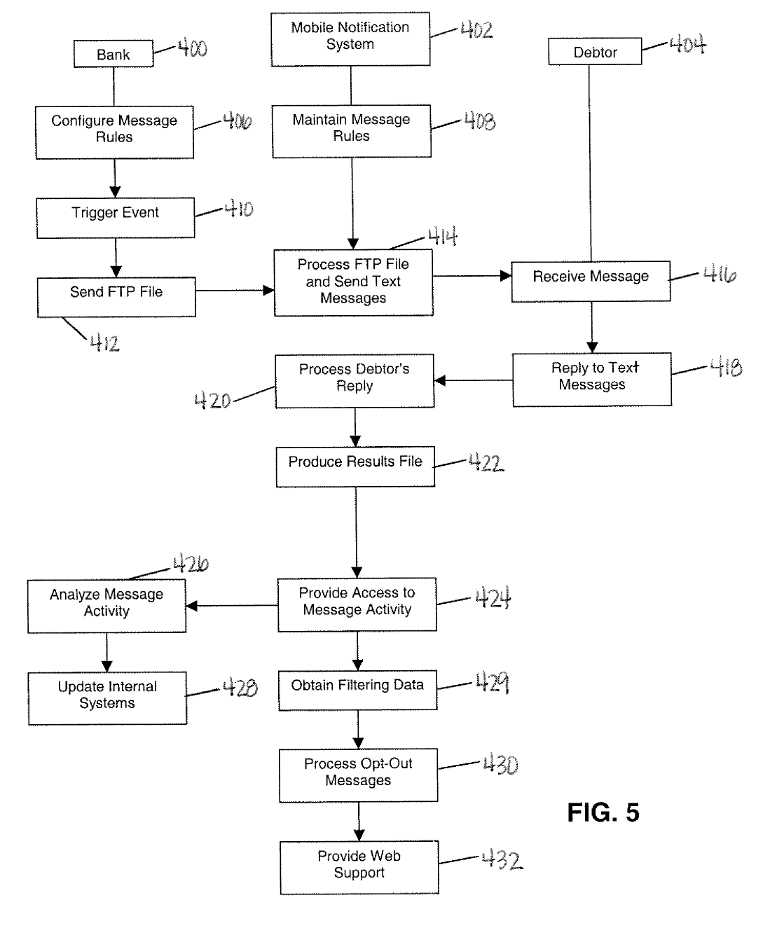

The operation of the Mobile Notification System will now be further described with respect to several examples. FIG. 5 shows a process flow diagram of one example of a Mobile Notification System according to an embodiment of the present invention. In this example, the MNS is implemented to support a bank or other lending institution. The Mobile Notification System orchestrates the technology and processes necessary to support proper notification or dialogue between the bank and its customers. While the system or process flow is presented in a particular order, it is not necessary to have any particular step occur in any particular order, each step may vary in time, order or occurrence.

FIG. 5 shows the interaction between the bank 400, MNS 402 and the bank's customer, a debtor 404. To enable the messaging process it is necessary to define rules that govern the message process. The MNS allows customers, i.e., the bank 400, to define the messages that will be sent, the scheduling of message distribution and any automatic message dialogue 406. Rules are recorded and maintained 408 in the Mobile Dialogue Engine. Once message rules are defined, the bank establishes trigger events 410 that will initiate text message alerts and/or dialogue. For example, when a payment reaches five days past due, the account may be flagged for text messaging. In other examples, triggers may be set at five days late, after seven days of failed telephone attempts, and at 55 days late, or at any other appropriate interval. Each trigger event can have a different associated text message assigned. On a daily basis, or some other interval, the bank identifies the accounts that satisfy trigger events and produces a trigger file. The file contains telephone numbers and any other necessary data fields. The bank encrypts the file and sends it to the FTP server 412 via secure file transfer protocol. In one example of a secure file transfer, the file is encrypted at the enterprise client and then transferred via encrypted file transfer. The MNS provides a secure folder location that is accessible to the enterprise customer. Once the file transfer is complete the file is automatically moved to another secure location on the MNS server. In the new location the file is decrypted and processed. Thus, in this example, the file is only moved and stored in an encrypted format. The moving of files takes place on the same physical server and may be performed via standard UNIX commands such as “mv”.

Returning to FIG. 5, the Mobile Enterprise Gateway monitors the FTP server for the arrival of new trigger files. Once an FTP file is delivered by the bank, it is processed by the MEG 414. The rules that apply to the file are retrieved from the MDE and the file is processed. The step of processing may include several additional steps. For instance, often the bank does not know which telephone numbers are assigned to mobile devices and which numbers are landlines. During this step in the process the MDE uses external data sources by way of the MRI to distinguish cellular numbers from landlines, thereby identifying the numbers that can accept text messages. The MDE also determines the actual cellular carrier that supports the particular telephone number. Using the data provided in the trigger file and instructions stored in the MDE, the system assembles the individual text messages that will be sent. Each message is created and stored. Depending upon the rules that are defined by the bank, messages may be sent immediately or they may be scheduled for distribution over an interval of time.

Once the appropriate time has arrived the message is sent, in step 414, from the MNS to the mobile carriers and subsequently to the debtor. Messages may be sent directly to the carriers or through one of their delegated text message aggregators. As an example, the MNS can establish secure communication with the wireless providers (or their designated text messaging partners) via Short Message Peer-to-Peer Protocol (SMPP). Messages are then passed from the MNS to the wireless carriers (Verizon, Cingular, etc.). The wireless carriers transfer the messages by way of their secure private networks to the individual cellular tower that is assigned to deliver the message to the cellular telephone. In some cases messages are transferred from the carrier to partners who operate towers for the carriers. These carriers comply with carrier security and reliability standards. The cellular tower transfers the message to the cellular telephone via frequency hopping modulation techniques which are standard within the industry. Frequency hopping allows the carriers to improve privacy, decrease interference, and increased signal capacity. This is one example of transmitting the text messages to identified users. Other known processes for transmitting the message to a wireless user are also contemplated.

Messages may be sent via standard rate messaging plans, free-to-end-user messaging, or via premium rate messaging. A “standard rate message” is the most common form of text message. Standard rate messaging means the sender is paying for the sending of the message, and the recipient is also going to be charged for receiving that message in accordance with their respective carrier agreements. If, for example, a user paid for a hundred text messages in a package, each message sent or received would be deducted from the total. Other carrier agreements result in the sender/receiver incurring a per-message fee. Another possible way of sending a message is to charge the recipient a premium for receiving messages from a sender. Such messages are referred to as “premium rate messages”. A premium message agreement may permit the sender to charge the recipient anywhere from $0.50 to $5.00 or more, maybe up to $30.00 for the receipt of that message. Premium rate messaging is not an intended mechanism for implementing the MNS, but is an available mechanism. Preferably, the MNS implements “free-to-end-user” messaging by pre-defined arrangements with each carrier. In most cases, the system aggregates the number of messages sent through each carrier, and bills back to the bank 400 the cost normally occurred by the debtor 404 in receiving the message. If the debtor's carrier does not bill per message but, instead, permits a certain number of included plan messages, the message received from the bank 400 is not docked from the number of plan messages permitted. In this way, the debtor 404 does not incur any cost in receiving the notice from the bank 400 either in terms of a fee or a recorded message event. Despite incurring the cost of the message to the debtor 404, the bank 400 still has spent less money than it would have otherwise incurred in a telephone call or traditional letter notification to the debtor.

Text messages are typically delivered to mobile devices by the carriers within one minute. Occasionally, mobile devices are turned off or are otherwise out of service. In those cases the individual mobile carriers continue to try to deliver messages for up to 36 hours. If the message cannot be delivered then the carrier will eventually discontinue trying. The debtor receives the text message 416 and determines a form of response 418.

Some debtors will reply to the text message with another text message. These messages will be sent to the cellular telephone towers, through the carrier's network and eventually to the MNS, in the process as described above. When these messages are received by the MNS, they are accumulated, encrypted and placed on the secure FTP server, and made available to the bank on a daily or periodic basis. Messages received by the MNS may also be stored in a password protected database.

The format of a debtor reply can be a text message, a multi-media message, or even an audible message. The type of text message may be an SMS message, or a Multi-Media Message (MMS). An example of an SMS response is the debtor typing the letters Y-E-S or N-O in response to the query “Have you paid your bill?”. In an MMS environment or richer protocol, the debtor reply may comprise two buttons which appear on the user's screen: “YES” and “NO”. The debtor can just touch the screen or hit enter to create a “YES” or a “NO” message response to the same query. Correlation rules may be utilized to link a first text message with a reply text message. One type of correlation rule may use outgoing or incoming identifiers or flags to implement this functionality. The dialogue may continue, per the rules established by the enterprise customer, according to the response received from the debtor. In this query example, a “thank you” message may be sent in reply to a YES response. Other debtors will respond with a telephone call to the banker's call center, or an email to the banker's website.

When a debtor replies with a text message, it is logged and processed in step 420. Some messages can be processed automatically; others will require manual intervention as described above. If a message is sent by the debtor with a recognizable keyword (exact-match reply) then the message may be processed automatically. Incoming messages are processed by the Mobile Dialogue Engine to determine if automatic processing is possible. Further, as described below, the MNS will automatically process messages that contain the following key words: HELP, STOP, END, QUIT, and EXIT. Keyword HELP will initiate an automatic message explaining the program. STOP, END, QUIT, and EXIT will result in an automatic termination of future messages to that phone number either related to this dialogue session, or any future sessions depending upon the rules established for a particular bank.

On a daily basis, or some other interval, the Mobile Notification System assembles the results of all message activity. This includes messages sent, messages confirmed to be delivered, messages that could not be delivered, etc. Messaging results are loaded into a report file in step 422. The file contains a record of all outbound and inbound activity. It is encrypted and placed on the secure FTP server, and made available to the bank in step 424. The bank may receive its report files via secure file transfer. Once the bank has retrieved the report file or accessed its messaging activity in step 426, it may use the data to update its customer relationship management systems or accounts receivable systems in step 428. In addition to viewing report files, the bank may also view messaging status reports manually via the Internet.

As described above in step 414, the Mobile Notification System obtains external data to distinguish cellular numbers from landlines. These filters are obtained in step 429. Several data sources may be included in this process, and the frequency of the update may depend upon the source.

The Mobile Notification System can also support opt-out message requests in step 430. If the debtor 404 does not want to receive payment alerts or any other form of message then they may reply to any message with the text, STOP, END, or QUIT, for example. The Mobile Notification System enforces that request by blocking all messages to that number until they specifically opt back into the program.

Occasionally debtors will have questions about the text messaging program. The Mobile Notification System provides a web based description of the program 432 which can be accessed by debtors as well as banks.

Again the above embodiment may be used to advantage other businesses, and is not necessarily limited to banking institutions.

The operation of the MNS can also be described in terms of the duties assigned to the MNS and to each enterprise customer. Again, in the example of a bank, these functions may be grouped as follows. The MNS may perform the following tasks as part of an enterprise customer agreement:

1. Initiate the environment for text messaging. Enable mobile terminated and mobile originated messages through the Mobile Dialogue Engine.

2. Filter telephone numbers to ensure that text messages are sent to valid mobile handsets.

3. Send messages at the specified times to the appropriate mobile carriers.

4. Receive, process, and maintain all text message replies.

5. Support automatic actions for HELP, STOP, END, QUIT, and EXIT.

6. Assemble and report results from text messaging dialogues.

7. Provide free-to-end-user messages.

8. Utilize an existing or new wireless short code.

9. Scrub telephone numbers to identify cellular numbers.

10. Provide secure access to the MNS web site for access to activity reports.

Correspondingly, the financial institution may provide the following as part of an enterprise customer agreement:

1. Definition of message content that will appear in each message.

2. Identified trigger events and message delivery expectations.

3. A list of customer telephone numbers.

4. If appropriate, unique data that will be included in each text message.

5. Timing objectives for message distribution.

6. Training for customer service representatives who will respond to calls.

7. Share data and analysis with MNS for evaluating.

8. Company liaison for addressing questions and issues.

The MNS may also have additional support functionality such as “opt in” and “opt out” features. One example of an Opt In function would require that all telephone numbers provided by enterprise customers be from legitimate established business relationships. The system may require that all mobile telephone subscribers that are contacted via the MDE have agreed that the telephone number(s) provided may be used for contacting the customer for the purpose of collecting delinquent debt. The Opt Out scenario may be as described above. To wit, the MNS may allow consumers to opt out of text message dialogue. Opt out might be supported through standard keywords such as STOP, END, QUIT, EXIT, and UNSUBSCRIBE. Opt out may also be supported through the enterprise customer's call center.

FIGS. 1-5 represent various aspects of the MNS. While communication between the wireless devices is conducted via wireless technologies, the other systems may be connected via landlines, communications networks or any other method or systems know to a person of skill in the art. Each of the individual system need not reside or be part of the same system; all that is necessary is communication capability between each of the system parts by wireless or physical technologies. Also, the connections between the various systems need not be as shown in the Figures.

While the system has been described in connection with one or more embodiments, it is not intended to be limited to these embodiments. Rather, the system covers all alternatives, modifications and equivalents as may be included in the spirit and scope of the appended claims.

1. A messaging system for enabling messaging dialogue between an enterprise and a client of the enterprise who has a mobile device operatively connected via a wireless communication link to a telecommunication network, the system comprising:
a Mobile Dialogue Engine (MDE) connected by a communications network to the enterprise, the MDE including program instructions stored in memory, the instructions comprising:
first instructions for receiving a plurality of message files from the enterprise, each message file including a client identity and message information, second instructions for associating a wireless device and a wireless service provider with each client identity,
third instructions for composing a mobile-terminated message to said wireless device of said identified client as a function of said message information, and fourth instructions for delivering said message to said client wireless device,
wherein at least two clients have different wireless service providers.

2. A system according to claim 1, wherein said program instructions further include instructions for securely retrieving said message files from a server accessible by said enterprise.

3. A system according to claim 1, wherein said program instructions further include instructions for receiving a mobile-originated message from said client in response to said mobile-terminated message and, thereafter, composing and delivering a second mobile-terminated message to said same wireless device as a function of at least one data field within said mobile-originated message.

4. A system according to claim 1, wherein said program instructions further include instructions for storing all message dialogues between an enterprise and said client.

5. A system according to claim 1, comprising a Mobile Enterprise Gateway (MEG) interface between the MDE and said enterprise, said MEG including program instructions stored in memory, the program instructions comprising instructions for preprocessing said message files from said enterprise for format validity.

6. A system according to claim 1, wherein said third instructions comprise a plurality of predefined message structures, and wherein said message information populates data fields within said message structures.

7. A system according to claim 1 comprising a Mobile Message Center (MMC) interface between the MDE and said enterprise, said MMC including program instructions stored in memory, the program instructions comprising instructions for composing a free-form mobile-terminated message to said wireless device of said identified client.

8. A system according to claim 5 comprising a Mobile Message Center (MMC) interface between the MDE and said enterprise, said MMC including program instructions stored in memory, the program instructions comprising instructions for composing a free-form mobile-terminated message to said wireless device of said identified client.

9. A system according to claim 6 comprising a Mobile Message Center (MMC) interface between the MDE and said enterprise, said MMC including program instructions stored in memory, the program instructions comprising instructions for composing a free-form mobile-terminated message to said wireless device of said identified client.

10. A system according to claim 1 comprising a Mobile Carrier Gateway (MCG) interfacing said MDE with said telecommunications network, said MCG including program instructions stored in memory, the program instructions comprising instructions for transmitting each mobile-terminated message to said wireless device of said identified client by said client's wireless service provider.

11. A system according to claim 10 wherein said MCG program instructions comprise Short Message Peer-to-Peer Protocol instructions.

12. A system according to claim 5 comprising a Mobile Carrier Gateway (MCG) interfacing said MDE with said telecommunications network, said MCG including program instructions stored in memory, the program instructions comprising instructions for transmitting each mobile-terminated message to said wireless device of said identified client by said client's wireless service provider.

13. A system according to claim 7 comprising a Mobile Carrier Gateway (MCG) interfacing said MDE with said telecommunications network, said MCG including program instructions stored in memory, the program instructions comprising instructions for transmitting each mobile-terminated message to said wireless device of said identified client by said client's wireless service provider.

14. A system according to claim 8 comprising a Mobile Carrier Gateway (MCG) interfacing said MDE with said telecommunications network, said MCG including program instructions stored in memory, the program instructions comprising instructions for transmitting each mobile-terminated message to said wireless device of said identified client by said client's wireless service provider.

15. A system according to claim 1 comprising a Mobile Regulation Integrator (MRI) operatively associated with said MDE, said MRI including program instructions stored in memory, the program instructions comprising instructions for validating a wireless device network number and a wireless service provider for each client identity.

16. A system according to claim 14 comprising a Mobile Regulation Integrator (MRI) operatively associated with said MDE, said MRI including program instructions stored in memory, the program instructions comprising instructions for validating a wireless device network number and a wireless service provider for each client identity.

17. A system according to claim 1, wherein said instructions further include instructions for allocating costs associated with delivering said message to said client wireless device to said enterprise such that said message is a free-to-end-user message.

18. A method for messaging between an enterprise and clients of the enterprise who each have a mobile device operatively connected via a wireless communication link to a telecommunication network, and wherein at least two clients have different wireless service providers, the method comprising:
receiving a plurality of message files from the enterprise, each message file including a client identity and message information,
associating a wireless device and a wireless service provider with each client identity,
composing a mobile-terminated message to said wireless device of said identified client as a function of said message information, and
delivering said message to said client wireless device.

19. A method according to claim 18 further comprising receiving a mobile-originated message from said client in response to said mobile-terminated message and, thereafter, composing and delivering a second mobile-terminated message to said same wireless device as a function of at least one data field within said mobile-originated message.

20. A method according to claim 18 further comprising storing all message dialogues between an enterprise and said clients.

21. A method according to claim 18 further comprising preprocessing said message files from said enterprise for format validity.

22. A method according to claim 19 wherein the step of receiving a mobile-originated message includes determining whether said mobile-originated message is at least one of an exact-match, free-form or invalid message format.

23. A method according to claim 22 comprising, when said mobile-originated message comprises a free-form message, transmitting said free-form message to a queue for manual processing.

24. A method according to claim 18 wherein the step of receiving is in response to said message files being transmitted from said enterprise to a secure server.

25. A method according to claim 18 comprising allocating a cost of delivering said message to said client wireless device to said enterprise such that said message is a free-to-end-user message.

26. A method for messaging between an enterprise and clients of the enterprise who each have a mobile device operatively connected via a wireless communication link to a telecommunication network, the method comprising:
identifying a plurality of clients in response to a common trigger event, at least two of said clients having different wireless service providers;
providing a data point for each of said clients, said data point correlating to a pre-defined message text; and
transmitting a message file to a server, said message file including said data points, said server being operatively connected to a gateway for delivering mobile-terminated messages as a function of said data points to said clients.

27. A method according to claim 26 comprising receiving a report indicating messaging activity with each of said clients.

28. A method according to claim 26 comprising, in response to said transmitting, receiving a mobile-originated message from at least one of said clients.

29. A method according to claim 28 comprising, in response to receiving, composing a free-form message, and transmitting said free-form message to said client.

30. A method according to claim 26 comprising selecting said pre-defined message text from a plurality of pre-defined message texts.

31. A method according to claim 26 comprising recording and reconciling costs associated with said client receiving said messages such that said messages are free-to-end-user messages.
